(19) United States
(12) Patent Application Publication
(10) Pub. No.: US 2017/0161933 A1
(43) Pub. Date: Jun. 8, 2017

(54) MOBILE VIRTUAL REALITY (VR) OPERATION METHOD, SYSTEM AND STORAGE MEDIA

(71) Applicant: INDUSTRIAL TECHNOLOGY RESEARCH INSTITUTE, Hsinchu (TW)

(72) Inventors: Tai-An CHEN, Hsinchu City (TW); Che-Wei LIANG, Taichung City (TW); Chun-Yen CHEN, Toufen City (TW); Shian WAN, Hsinchu County (TW)

(73) Assignee: INDUSTRIAL TECHNOLOGY RESEARCH INSTITUTE, Hsinchu (TW)

(21) Appl. No.: 14/979,699

(22) Filed: Dec. 28, 2015

(30) Foreign Application Priority Data
Dec. 3, 2015 (TW) 104140569

(51) Int. Cl. G06T 15/00; H04N 5/225; G06F 3/01

(52) U.S. Cl. CPC G06T 15/00; G06F 3/012; H04N 5/225; G06T 2215/16

(57) ABSTRACT

A mobile Virtual Reality (VR) system includes a display unit, a sensing unit, a photographing unit and a VR application. The sensing unit senses a physical movement variation of the mobile VR system. The photographing unit photographs environment to generate a photograph image. Based on the physical movement variation of the mobile VR system from the sensing unit and the photograph image from the photographing unit, the VR application determines a movement status of the mobile VR system to adjust a VR display image on the display unit.

### CROSS-REFERENCE TO RELATED ART

This application claims the benefit of Taiwan application Serial No. 104140569, filed Dec. 3, 2015, the disclosure of which is incorporated by reference herein in its entirety.

### TECHNICAL FIELD

The disclosure relates in general to a mobile virtual reality (VR) operation method, system and storage media.

### BACKGROUND

In virtual reality (VR) world, computer generates 3D virtual world, and user may search/observe the objects real-time and unlimited in the 3D virtual world by visual, hearing and touching and so on. When the user moves, the computer may generate corresponding 3D images by instant complex computation, and accordingly, the user may feel that the environment is moving. Therefore, VR system may meet people's need as much as possible.

Most of VR system provides visual experience to the user. The user may communicate with the VR system via the input device, such as keyboard, mouse and wired glove. The VR technology is limited by computer processing ability, image resolution and communication bandwidth. However, as technology develops, the computer processing ability, image resolution and communication bandwidth are also improved and more cost down. The limitation on the VR technology will be less in the future.

### SUMMARY

The disclosure is directed to a mobile virtual reality (VR) operation method, system and storage media. The movement status of the mobile VR system is determined to control the display of the VR image.

According to one embodiment, a mobile virtual reality (VR) system is provided. The mobile VR system includes a display unit, a sensing unit, a photographing unit and a VR application. The sensing unit is for sensing a physical movement variation of the mobile VR system. The photographing unit is for photographing environment to generate a photograph image. The VR application is for determining a movement status of the mobile VR system based on the physical movement variation of the mobile VR system, sensed by the sensing unit, and the photograph image from the photographing unit to adjust a VR display image on the display unit.

According to another embodiment, a mobile VR operation method for a mobile VR system is provided. A physical movement variation of the mobile VR system is sensed. Environment is photographed to generate a photograph image. A movement status of the mobile VR system is determined based on the physical movement variation of the mobile VR system and the photograph image to adjust a VR display image on the mobile VR system.

According to an alternative embodiment, a computer-readable non-transitory storage media is provided. When the computer-readable non-transitory storage media is read by a computer, the computer executes the above mobile virtual reality operation method.

### BRIEF DESCRIPTION OF THE DRAWINGS

FIG. 1 shows a function block diagram for a mobile virtual reality (VR) system according to an embodiment of the application.

FIG. 2 shows a flow chart for a mobile VR operation method according to an embodiment of the application.

FIG. 3A-3D show relationship between the detected movement amount and a (first/second) threshold according to an embodiment of the application.

FIG. 4A-4B show that the VR application commands the user to tilt forward according to an embodiment of the application.

FIG. 5A-5B show that the VR application commands the user to tilt backward according to an embodiment of the application.

FIG. 6A-6B show that the VR application displays the VR image on the display unit according to an embodiment of the application.

FIG. 7A-7B show that the user wears the mobile VR system on user head.

FIG. 8A-8C show a structure diagram of a head-mounted case of the mobile VR system according to an embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

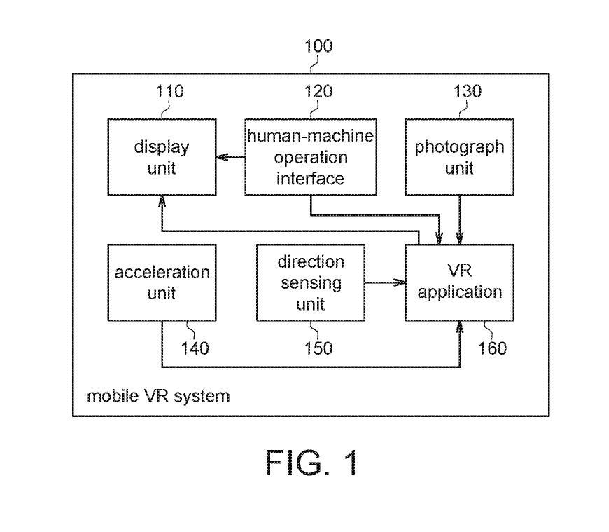

FIG. 1 shows a function block diagram for a mobile virtual reality (VR) system according to an embodiment of the application. The mobile VR system 100 includes a display unit 110, a human-machine operation interface 120, a photograph unit 130, a sensing unit (an acceleration unit (or an accelerometer) 140, a direction sensing unit 150) and a VR application 160. The mobile VR system 100 is implemented for example but not limited by a smart mobile device.

The display unit 110 is for real-time displaying the VR image from the VR application.

The human-machine operation interface 120 provides an operation interface for the user to operate the mobile VR system 100.

The photograph unit 130 photographs environment to generate a photograph image. The photograph unit 130 is for example but not limited by a rear camera of the smart mobile device. In one embodiment, the rear camera refers to the camera on the back side of the smart mobile device, and on the contrary, the display unit 110 is on the front side of the smart mobile device. That is, the display unit 110 and the photograph unit 130 are on opposite sides of the smart mobile device. The photograph image from the photograph unit 130 is sent to the VR application 160. Accordingly, the VR application 160 determines whether the image is zoom-in or zoom-out to further determine that whether the mobile VR system 100 tilts (or moves) forward, or backward or is still.

The acceleration unit 140 is for sensing an acceleration sensing value of the mobile VR system 100. The acceleration unit 140 is for example but not limited by, a G-sensor. The acceleration sensing value sensed by the acceleration unit 140 may be sent to the VR application 160 to further determine that whether the mobile VR system 100 tilts (or moves) forward, or backward or is still.

The direction sensing unit 150 is for sensing an angle sensing value of the mobile VR system 100. The direction sensing unit 150 is for example but not limited by, a gyroscope. The angle sensing value sensed by the direction sensing unit 150 may be sent to the VR application 160 to further determine that whether the mobile VR system 100 tilts (or moves) forward, or backward or is still.

Based on the photograph image from the photograph unit 130, the acceleration sensing value sensed by the acceleration unit 140 and the angle sensing value sensed by the direction sensing unit 150, the VR application 160 determines whether the mobile VR system 100 tilts (or moves) forward, or backward or is still. Further, based on the determination result, the VR application 160 displays the VR image real-time on the display unit 110 and accordingly the user may view the VR image real-time. The VR images are stored in the memory (not shown) which is read out by the VR application 160 and displayed on the display unit 110.

Further, the mobile VR system 100 may optionally include a communication unit.

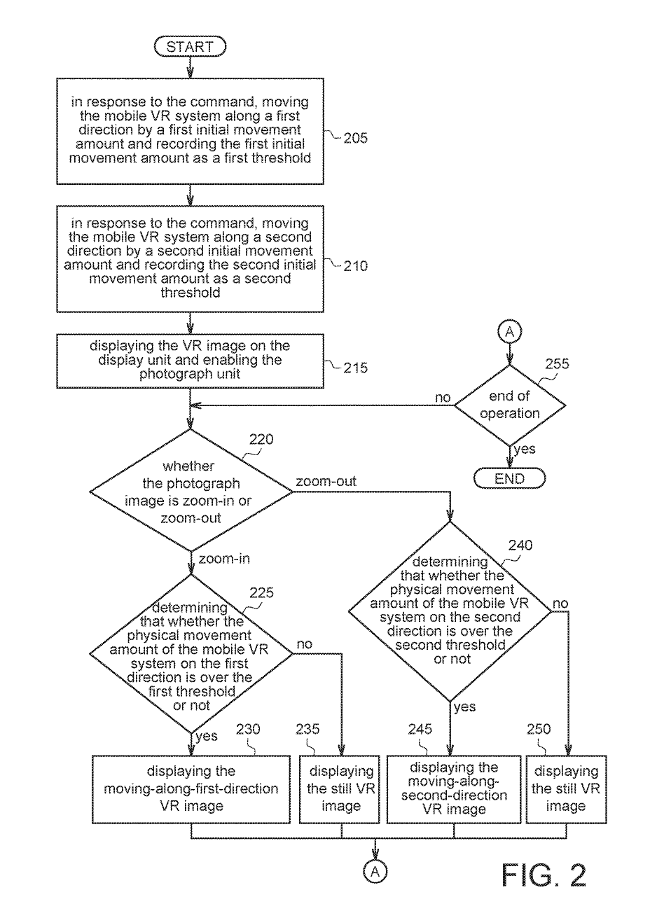

FIG. 2 shows a flow chart for a mobile virtual reality operation method according to an embodiment of the application. In step 205, in initial setting, the user is instructed to move a first predetermined distance along a first direction (for example but not limited by, forward) based on commands. In one embodiment, the commands are from the VR application 160. In response to the command, the user moves the mobile VR system 100 along the first direction by a first initial movement amount and the VR application 160 records the detected first initial movement amount as a first threshold. In the following, for example but not limited by, the VR application 160 predicts the first initial movement amount of the mobile VR system 100 based on the acceleration sensing value sensed by the acceleration unit 140. For example, in response to the command from the VR application 160, the user may tilt/move the mobile VR system 100 forward by 15 cm (by wearing the mobile VR system 100 on user head). Besides, although the user is commanded to move the mobile VR system 100 by 15 cm (for example), the first initial movement of the mobile VR system 100 caused by user may be not precisely as 15 cm, and the first initial movement may be 14 or 16 cm.

Similarly, in step 210, in initial setting, the VR application 160 commands the user to move a second predetermined distance along a second direction (for example but not limited by, backward). In response to the command, the user moves the mobile VR system 100 along the second direction by a second initial movement amount and the VR application 160 records the detected second initial movement amount as a second threshold. In the following, for example but not limited by, the VR application 160 predicts the second initial movement amount of the mobile VR system 100 based on the acceleration sensing value sensed by the acceleration unit 140. For example, in response to the command from the VR application 160, the user may tilt/move the mobile VR system 100 backward by 15 cm. Besides, although the user is commanded to move the mobile VR system 100 by 15 cm, the second initial movement of the mobile VR system 100 caused by user may be not precisely as 15 cm, and the second initial movement may be 14 or 16 cm.

In other possible embodiment of the application, the first threshold and the second threshold may be obtained via computation. That is, the steps 205 and 210 may be skipped and the VR application 160 obtains the first threshold and the second threshold via computation. Alternatively, after the first threshold and the second threshold are obtained in steps 205 and 210, the first threshold and the second threshold may be further processed.

In step 215, the VR application 160 displays the VR image on the display unit 110 and enables the photograph unit 130. In other words, the use may view the VR image on the display unit 110 to have VR experience.

In the embodiment of the application, the image from the photograph unit 130 may be used to determine whether the image is zoom-in or zoom-out.

In step 220, the VR application 160 determines that whether the photograph image from the photograph unit 130 is zoom-in or zoom-out. The details of how to determine that whether the photograph image from the photograph unit 130 is zoom-in or zoom-out is not specified here. If the VR application 160 determines that the photograph image from the photograph unit 130 is zoom-in, the flow proceeds to step 225. On the contrary, if the VR application 160 determines that the photograph image from the photograph unit 130 is zoom-out, the flow proceeds to step 230. In the embodiment of the application, in operation, if the mobile VR system 100 is tilted forward, the photograph image from the photograph unit 130 will be zoom-in because the photograph unit 130 is near to the objects under photographing. On the contrary, if the mobile VR system 100 is tilted backward, the photograph image from the photograph unit 130 will be zoom-out because the photograph unit 130 is away from the objects under photographing. Thus, in the embodiment of the application, the determination of whether the photograph image from the photograph unit 130 is zoom-in or zoom-out is used to determine that whether the mobile VR system 100 tilts forward or backward.

When the user operates the mobile VR system 100, the user may tilt forward or backward. Thus, the mobile VR system 100 may detects its own movement amount. In step 225, the VR application 160 determines that whether the physical movement amount of the mobile VR system 100 on the first direction is over the first threshold or not (that is, the VR application 160 determines whether the mobile VR system 100 tilts forward and if yes, the VR application determines the physical forward movement amount is over the first threshold or not). If the step 225 is yes (that is, the VR application determines the physical forward movement amount is over the first threshold), it is determined that the user tilts forward (i.e. tilts toward the first direction) and in step 230, the VR application 160 displays the moving-along-first-direction VR image on the display unit 110.

If the step 225 is no (that is, although the VR application determines the mobile VR system 110 tilts forward but the physical forward movement amount of the mobile VR system is not over the first threshold), it is determined that the user is still. In step 235, the VR application 160 displays the still VR image on the display unit 110.

In step 240, the VR application 160 determines that the physical movement amount of the mobile VR system 100 on the second direction is over the second threshold or not (that is, the VR application 160 determines whether the mobile VR system 100 tilts backward and if yes, the VR application determines the physical backward movement amount is over the second threshold or not). If the step 240 is yes (that is, the VR application determines that the physical backward movement amount of the mobile VR system 100 is over the second threshold), it is determined that the user tilts backward (i.e. tilts toward the second direction) and in step 245, the VR application 160 displays the moving-along-second-direction VR image on the display unit 110.

If the step 240 is no (that is, although the VR application determines the mobile VR system 110 tilts backward but the physical backward movement amount of the mobile VR system is not over the second threshold), it is determined that the user is still. In step 250, the VR application 160 displays the still VR image on the display unit 110.

That is, in the embodiment of the application, during operation of the mobile VR system 100, if the user wants to view moving-forward VR image, then the user may tilt or move forward in enough physical movement amount, and accordingly the physical forward movement amount of the mobile VR system 100 is over the first threshold. If the user wants to view the still VR image, the user may stand still (neither forward nor backward). If the user wants to view moving-backward VR image, then the user may tilt or move backward in enough physical movement amount, and accordingly the physical backward movement amount of the mobile VR system 100 is over the second threshold.

In step 255, the VR application 160 determines whether the use operation is ended. If yes, the flow ends. If not, the flow jumps back to the step 220.

Further, in the embodiment of the application, if the user wants to view the VR image on his/her right hand or left hand, the user may be still and then turn to the desired direction. Then the user may execute the flow chart in FIG. 2 to view VR image on his/her right hand or left hand.

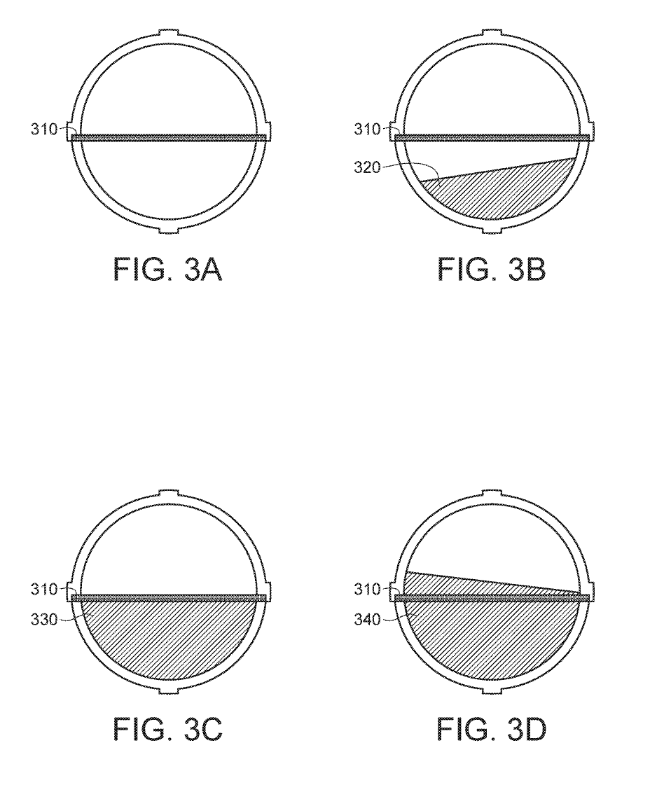

FIG. 3A-3D show relationship between the detected movement amount and the (first/second) threshold according to an embodiment of the application. FIG. 3A shows initialization of the gyroscope and the reference symbol 310 refers to the first/second threshold. FIG. 3B shows that the detected physical movement amount 320 is not over the (first/second) threshold 310. FIG. 3C shows that the detected physical movement amount 330 reaches the (first/second) threshold 310. FIG. 3D shows that the detected physical movement amount 330 is over the (first/second) threshold 310.

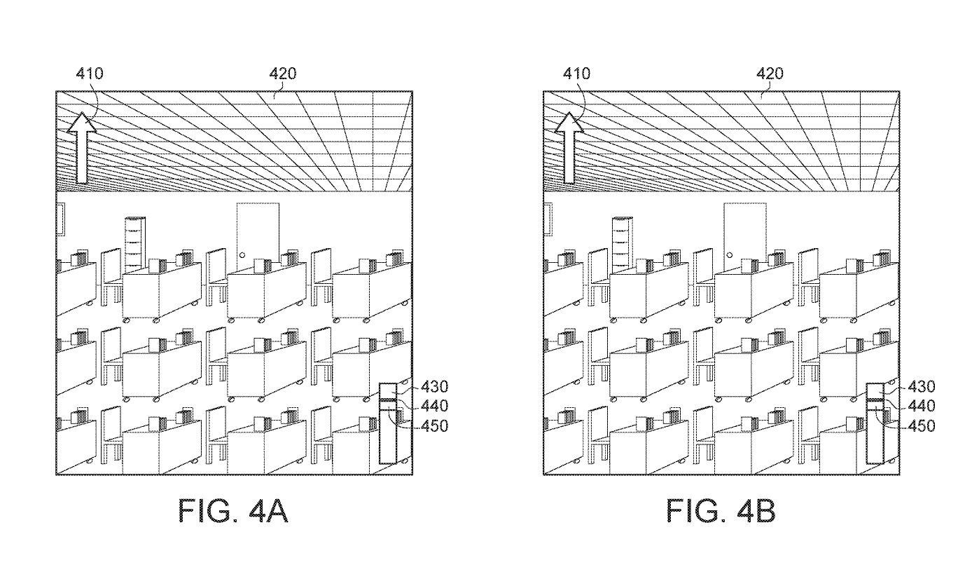

FIG. 4A-4B show that the VR application 160 commands the user to tilt forward according to an embodiment of the application. FIG. 4A and FIG. 4B show the content for user left eye and for user right eye, respectively. Thus, FIG. 4A and FIG. 4B are the same.

As shown in FIG. 4A and FIG. 4B, in commanding the user to tilt forward (as in step 205), the VR application 160 displays the command (a forward arrow) 410 on the display unit 110 to help the user in understanding. Besides, the VR application 160 may display the VR image 420 on the display unit 110. Further, the VR application 160 may display the tilt meter 430, the (first/second) threshold 440 and the detected movement amount 450 on the display unit 110.

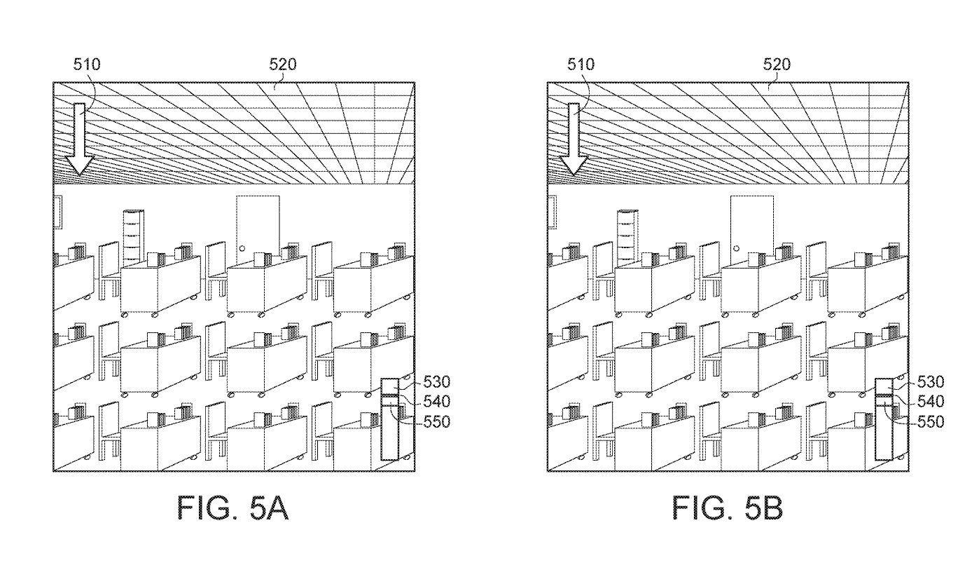

FIG. 5A-5B show that the VR application 160 commands the user to tilt backward according to an embodiment of the application. FIG. 5A and FIG. 5B show the content for user left eye and for user right eye, respectively. Thus, FIG. 5A and FIG. 5B are the same.

As shown in FIG. 5A and FIG. 5B, in commanding the user to tilt backward (as in step 210), the VR application 160 displays the command (a backward arrow) 510 on the display unit 110 to help the user in understanding. Besides, the VR application 160 may display the VR image 520 on the display unit 110. Further, the VR application 160 may display the tilt meter 530, the (first/second) threshold 540 and the detected movement amount 550 on the display unit 110.

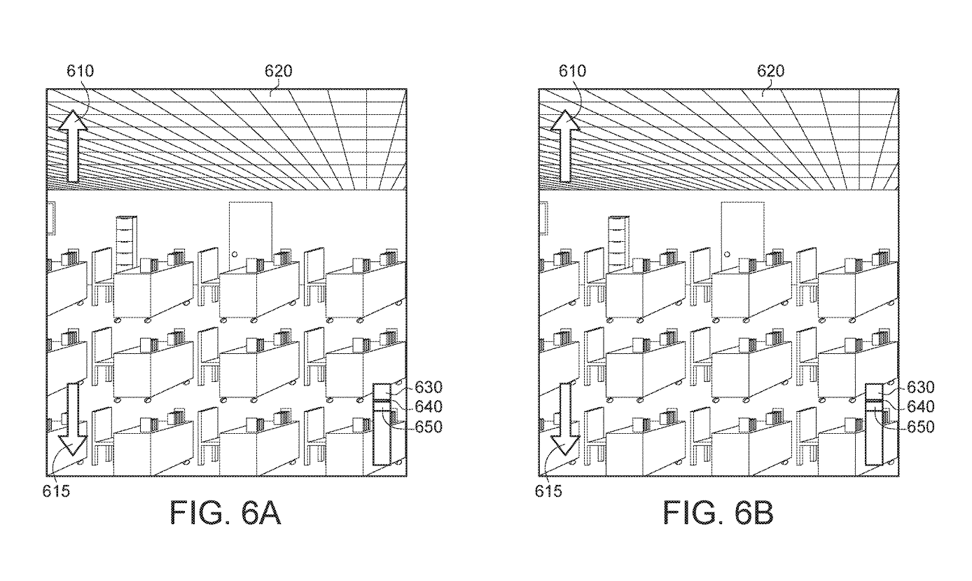

FIG. 6A-6B show that the VR application 160 displays the VR image on the display unit 110 according to an embodiment of the application. FIG. 6A and FIG. 6B show the content for user left eye and for user right eye, respectively. Thus, FIG. 6A and FIG. 6B are the same.

As shown in FIG. 6A and FIG. 6B, in AR display and/or operation, (as in step 215), the VR application 160 displays the command (the forward arrow) 610 and the command (the backward arrow) 615 on the display unit 110. Besides, the VR application 160 may display the VR image 620 on the display unit 110. Further, the VR application 160 may display the tilt meter 630, the (first/second) threshold 640 and the detected movement amount 650 on the display unit 110.

As shown in FIG. 6A and FIG. 6B, by viewing the tilt meter 630, the (first/second) threshold 640 and the detected movement amount 650 on the display unit 110, the user may easily control the display of the VR image. For example, if the user wants to view the moving-forward VR image on the display unit 110, the user may control the movement amount 650 of the mobile VR system 100 to be over the (first/second) threshold 640. On contrary, if the user wants to view the still VR image on the display unit 110, the user may control the movement amount 650 of the mobile VR system 100 to be under the (first/second) threshold 640.

In an embodiment of the application, the details about how the VR application 160 determines whether the mobile VR system 100 moves/tilts backward or forward are as follows. For example, if the frame rate of the photograph unit 130 is 18-35 FPS (frame per second) and the sampling rate of the acceleration sensing unit 140 is 15-197 Hz, the embodiment of the application may have a better and precise determination by adopting image scaling detection and the angle/direction sensing value and the acceleration sensing value from the direction sensing unit 150 and the acceleration sensing unit 140.

Further, in an embodiment of the application, each pixel is defined by a motion vector. The motion vector is classified by four directions. If the pixel is on any direction of the four directions, then the motion vector of this pixel is 1 (here, we use I/O as an example for explaining, but not limit to). On the contrary, if the pixel is on none of the four directions, then the motion vector of this pixel is 0. A histogram is obtained by gathering the motion vectors of all pixels. Then the pattern of the histogram is judged to determine that whether the mobile VR system 100 moves/tilts backward or forward.

Of course, the VR application may use other algorithm in determining whether the mobile VR system 100 moves/tilts backward or forward and the details are omitted here.

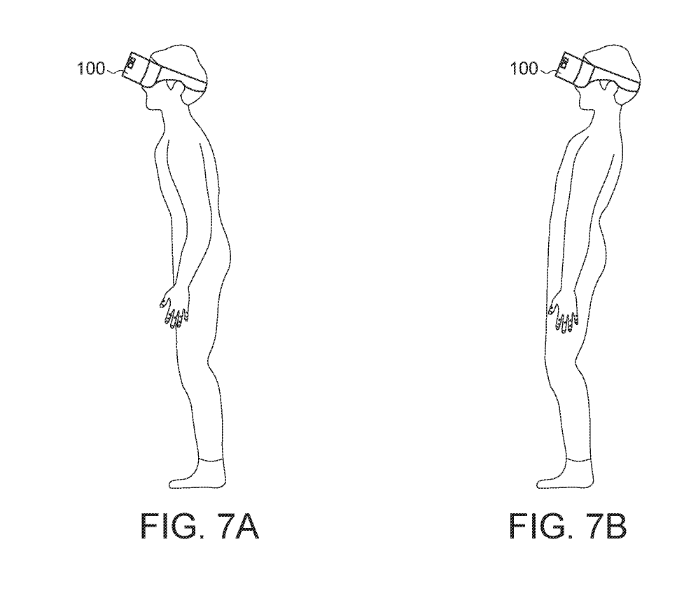

FIG. 7A-7B show that the user wears the mobile VR system on user head. As shown in FIG. 7A, when the user tilts forward (over the first threshold), the VR application 160 of the mobile VR system 100 displays the moving-forward VR image. As shown in FIG. 7B, when the user tilts backward (over the second threshold), the VR application 160 of the mobile VR system 100 displays the moving-backward VR image.

That is, in the embodiment of the application, in operation, if the user tilts forward enough (over the first threshold), the user may view the moving-forward VR image on the display unit 110. When the user is sill or tilts backward enough (over the second threshold), the user may view the still or moving-backward VR image on the display unit 110.

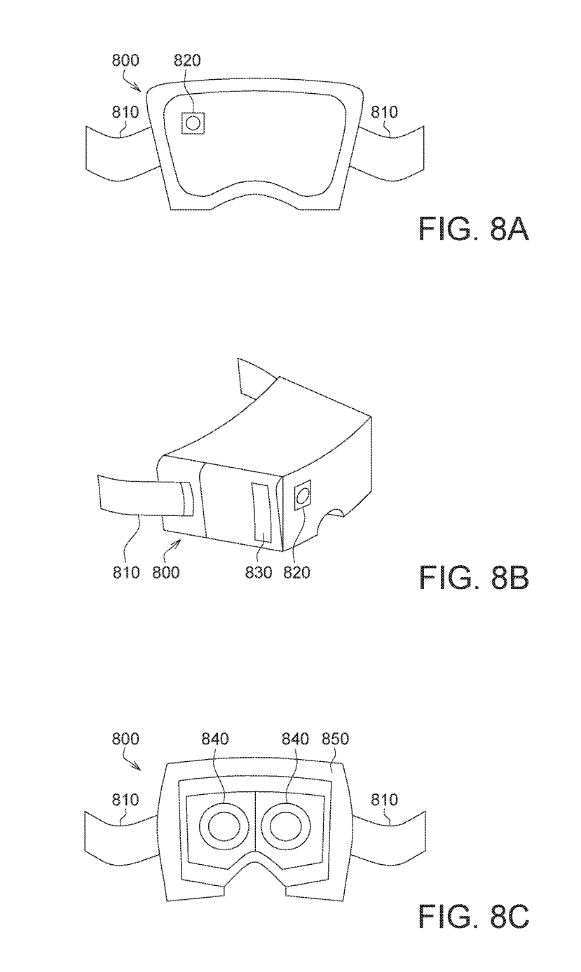

FIG. 8A-8C show a structure diagram of a head-mounted case according to an embodiment of the application. In order to facilitate in wearing the mobile VR system 100, the mobile VR system 100 in an embodiment of the application includes a head-mounted case 800. The head-mounted case 800 may hold the smart mobile device.

FIG. 8A shows a front view of the head-mounted case according to the embodiment of the application. FIG. 8B shows a side view of the head-mounted case according to the embodiment of the application. FIG. 8C shows a back view of the head-mounted case according to the embodiment of the application.

The head-mounted case 800 includes an elastic band 810, an adjustable camera hole 820, a recess 830, two lens 840 and a soft cushion 850.

The elastic band 810 extends from two sides of the head-mounted case and is fastened to the user head. The adjustable camera hole 820 may be adjusted based on a size and a location of the photographing unit 130 to expose the photographing unit 130. The recess 830 is for receiving a smart mobile device. The lens 840 are corresponding to a left eye and a right eye of the user, respectively. The lens 840 are corresponding to a left half and a right half of the display unit 110, respectively. The lens 840 will enlarge the VR images displayed on the left half and the right half of the display unit 110, respectively. The soft cushion 850 surrounds the lens 840. The soft cushion 850 is for example, a sponge which adds soft experience to user when touched to user face.

Based on the sensing result from the sensing unit (which represent the physical movement variation of the mobile VR system 100), the mobile VR system 100 of the embodiment of the application may determine the movement status (moving forward, backward or still) and accordingly adjust the VR images.

In the embodiment of the application, it is enough to sense the user operation (tilting forward, backward or still) by the acceleration sensing unit, the direction sensing unit and the photograph unit, for controlling display of the VR image. The acceleration sensing unit, the direction sensing unit and the photograph unit are common to the modern smart phone. That is, the mobile VR system 100 of the embodiment of the application could control the display of the VR image without additional control means. Thus, the mobile VR system 100 of the embodiment of the application has an advantage of cost down.

Besides, in detecting and determining the user operation (tilting forward, backward or still), the mobile VR system 100 considers whether the photograph image is zoom-in or zoom-out, the acceleration sensing value and the direction sensing value. Therefore, the detecting result is more accurate and will not be easily affected by noises.

Further, in initial setting of the mobile VR system 100 of the embodiment of the application, each user sets his/her own first/second threshold (that is, the respective thresholds reflecting the moving/tilting habit of the user). That is, the mobile VR system 100 of the embodiment of the application may fine tunes the first/second threshold for each user. Thus, even if each user may have different forward or backward tilting angle, after fine tune on the first/second threshold, in the mobile VR system 100 of the embodiment of the application, the forward or backward tilting detection will be not easily affected by user difference. Thus, the detection will be more precise.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A mobile virtual reality (VR) system, comprising:
a display unit;
a sensing unit, for sensing a physical movement variation of the mobile VR system;
a photographing unit, for photographing environment to generate a photograph image; and
a VR application, for determining a movement status of the mobile VR system based on the physical movement variation of the mobile VR system, sensed by the sensing unit, and the photograph image from the photographing unit to adjust a VR display image on the display unit.

2. The mobile virtual reality system according to claim 1, wherein
the sensing unit includes an acceleration unit and a direction sensing unit; and
the physical movement variation of the mobile VR system includes an acceleration sensing value and an angle sensing value.

3. The mobile virtual reality system according to claim 1, wherein
if the VR application determines that the mobile VR system tilts or moves along a first direction, then the VR application displays a moving-along-first-direction VR image on the display unit;
if the VR application determines that the mobile VR system is still, then the VR application displays a still VR image on the display unit; and
if the VR application determines that the mobile VR system tilts or moves along a second direction, then the VR application displays a moving-along-second-direction VR image on the display unit.

4. The mobile virtual reality system according to claim 1, wherein in initial setting,
in response to a first command from the VR application, the mobile VR system moves a first initial movement along a first direction, and the VR application records the first initial movement as a first threshold; and in response to a second command from the VR application, the mobile VR system moves a second initial movement along a second direction, and the VR application records the second initial movement as a second threshold; or
the VR application obtains the first threshold and the second threshold via computation.

5. The mobile virtual reality system according to claim 4, wherein the VR application displays the VR display image on the display unit and enables the photograph unit.

6. The mobile virtual reality system according to claim 5, wherein the VR application determines whether the photograph image from the photographing unit is zoom-in or zoom-out.

7. The mobile virtual reality system according to claim 6, wherein if the VR application determines that the photograph image from the photographing unit is zoom-in,
the VR application determines that whether a first physical movement amount of the mobile VR system along the first direction is over the first threshold,
if the first physical movement amount of the mobile VR system along the first direction is over the first threshold, the VR application displays a moving-along-first-direction VR image on the display unit; and
if the first physical movement amount of the mobile VR system along the first direction is not over the first threshold, the VR application displays a still VR image on the display unit.

8. The mobile virtual reality system according to claim 6, wherein if the VR application determines that the photograph image from the photographing unit is zoom-out,
the VR application determines that whether a second physical movement amount of the mobile VR system along the second direction is over the second threshold,
if the second physical movement amount of the mobile VR system along the second direction is over the second threshold, the VR application displays a moving-along-second-direction VR image on the display unit; and
if the second physical movement amount of the mobile VR system along the second direction is not over the second threshold, the VR application displays a still VR image on the display unit.

9. The mobile virtual reality system according to claim 1, further comprising a head-mounted case including:
an elastic band, extending from two sides of the head-mounted case;
an adjustable camera hole, configured to be adjusted based on a size and a location of the photographing unit to expose the photographing unit;
a recess, for receiving a smart mobile device;
a plurality of lens, corresponding to a left half and a right half of the display unit, respectively; and
a soft cushion, for surrounding the lens.

10. A mobile virtual reality (VR) operation method for a mobile VR system, comprising:
sensing a physical movement variation of the mobile VR system;
photographing environment to generate a photograph image; and
determining a movement status of the mobile VR system based on the physical movement variation of the mobile VR system and the photograph image to adjust a VR display image on the mobile VR system.

11. The mobile virtual reality operation method according to claim 10, wherein the step of sensing the physical movement variation of the mobile VR system includes:
sensing an acceleration sensing value and an angle sensing value of the mobile VR system.

12. The mobile virtual reality operation method according to claim 10, wherein
if it is determined that the mobile VR system tilts or moves along a first direction, then a moving-along-first-direction VR image is displayed on the mobile VR system;
if it is determined that the mobile VR system is still, then a still VR image is displayed on the mobile VR system; and
if it is determined that the mobile VR system tilts or moves along a second direction, then a moving-along-second-direction VR image is displayed on the mobile VR system.

13. The mobile virtual reality operation method according to claim 10, wherein in initial setting,
in response to a first command, the mobile VR system moves a first initial movement along a first direction, and the first initial movement is recorded as a first threshold; and in response to a second command, the mobile VR system moves a second initial movement along a second direction, and the second initial movement is recorded as a second threshold; or
a VR application of the mobile VR system obtains the first threshold and the second threshold via computation.

14. The mobile virtual reality operation method according to claim 13, wherein the VR display image is displayed on a display unit of the mobile VR system.

15. The mobile virtual reality operation method according to claim 14, further including:
determining whether the photograph image is zoom-in or zoom-out.

16. The mobile virtual reality operation method according to claim 15, wherein if it is determined that the photograph image is zoom-in,
determining that whether a first physical movement amount of the mobile VR system along the first direction is over the first threshold,
if the first physical movement amount of the mobile VR system along the first direction is over the first threshold, displaying a moving-along-first-direction VR image on the display unit; and
if the first physical movement amount of the mobile VR system along the first direction is not over the first threshold, displaying a still VR image on the display unit.

17. The mobile virtual reality operation method according to claim 15, wherein if it is determined that the photograph image is zoom-out,
determining that whether a second physical movement amount of the mobile VR system along the second direction is over the second threshold,
if the second physical movement amount of the mobile VR system along the second direction is over the second threshold, displaying a moving-along-second-direction VR image on the display unit; and
if the second physical movement amount of the mobile VR system along the second direction is not over the second threshold, displaying a still VR image on the display unit.

18. A computer-readable non-transitory storage media, when read by a computer, the computer executing the mobile virtual reality (VR) operation method of claim 10.
